(19) United States
(12) Patent Application Publication
(10) Pub. No.: US 2025/0002672 A1
(43) Pub. Date: Jan. 2, 2025

(54) DEPOLYMERIZATION LIQUID GENERATION DEVICE

(71) Applicant: Honda Motor Co., Ltd., Tokyo (JP)

(72) Inventors: Tsuyoshi Baba, Wako-shi (JP); Shuta Suzuki, Wako-shi (JP)

(21) Appl. No.: 18/749,621

(22) Filed: Jun. 21, 2024

(30) Foreign Application Priority Data
Jun. 27, 2023 (JP) 2023-105292

(51) Int. Cl. C08J 11/14

(52) U.S. Cl. CPC C08J 11/14; C08J 2300/30

(57) ABSTRACT

Depolymerization liquid generation device includes: depolymerization liquid generation unit configured to knead plastic and water under heating environment to generate depolymerization liquid; back pressure valve configured to adjust pressure of depolymerization liquid from depolymerization liquid generation unit; first heat exchange unit provided in flow path between depolymerization liquid generation unit and back pressure valve; second heat exchange unit provided in supply path of water supplied to depolymerization liquid generation unit; temperature controller configured to adjust temperature of heat medium circulating through first heat exchange unit and second heat exchange unit; and switching valve configured to switch between first flow path for circulating heat medium from temperature controller to temperature controller through first heat exchange unit and second flow path for circulating heat medium from temperature controller to temperature controller through first heat exchange unit and second heat exchange unit.

### CROSS-REFERENCE TO RELATED APPLICATION

This application is based upon and claims the benefit of priority from Japanese Patent Application No. 2023-105292 filed on Jun. 27, 2023, the content of which is incorporated herein by reference.

### BACKGROUND OF THE INVENTION

### Field of the Invention

The present invention relates to a depolymerization liquid generation device configured to depolymerize plastic to generate depolymerization liquid.

### Description of the Related Art

As this type of technology, there has been known a device for mixing waste plastic and water and heating the mixture to cause a decomposition reaction of the waste plastic is known (see, for example, JP 2001-181651 A).

When a depolymerization liquid after the decomposition reaction is excessively cooled, thermal energy at the time of concentration operation of the depolymerization liquid is increased in a process after a decomposition process. In addition, when the operation of the device starts, there is a risk that a flow path of the depolymerization liquid is closed and the stable operation of the device is hindered, due to, for example, an increase in the viscosity of a part of a non-depolymerization liquid having an insufficient decomposition reaction.

The stable operation and the energy saving of the device contribute to the development of sustainable waste plastic processing technology.

### SUMMARY OF THE INVENTION

An aspect of the present invention is a depolymerization liquid generation device, including: a depolymerization liquid generation unit configured to knead plastic and water under a heating environment to generate depolymerization liquid; a back pressure valve configured to adjust pressure of the depolymerization liquid from the depolymerization liquid generation unit; a first heat exchange unit provided in a flow path between the depolymerization liquid generation unit and the back pressure valve; a second heat exchange unit provided in a supply path of the water supplied to the depolymerization liquid generation unit; a temperature controller configured to adjust temperature of heat medium circulating through the first heat exchange unit and the second heat exchange unit; and a switching valve configured to switch between a first flow path for circulating the heat medium from the temperature controller to the temperature controller through the first heat exchange unit and a second flow path for circulating the heat medium from the temperature controller to the temperature controller through the first heat exchange unit and the second heat exchange unit.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating an example of a configuration of a depolymerization liquid generation device according to an embodiment of the present invention; and

FIG. 2 is a flow chart illustrating an example of process flow during operation of the depolymerization liquid generation device.

### DETAILED DESCRIPTION OF THE INVENTION

### <Overview>

A depolymerization liquid generation device according to an embodiment reduces thermal energy used in the depolymerization liquid generation device and its surroundings in a decomposition process of a plastic chemical recycling system using a depolymerization reaction using water as a medium under subcritical conditions.

The depolymerization liquid generation device generates a depolymerization liquid by reacting a polyamide resin (for example, PA6) as plastic with water in a high-temperature and high-pressure (for example, 350° C. and 17 MPa) environment. The depolymerization liquid contains ϵ-caprolactam (decomposition product). After heat is exchanged between the depolymerization liquid at a high temperature (350° C. described above) and heat medium oil (hereinafter, simply referred to as a heat medium) to heat the heat medium, the heat is exchanged with supply water using the heated heat medium, thereby reducing heating energy for the supply water.

However, when the temperature of the depolymerization liquid is excessively lowered by the heat exchange with respect to the depolymerization liquid at a high temperature, a large amount of heat energy is required at the time of concentration operation in a process after the decomposition process. Therefore, by appropriately controlling the temperature of the depolymerization liquid by the heat exchange, it is possible to suppress the thermal energy used in the process after the decomposition process.

Furthermore, at the time of start operation in the case of cold start of the depolymerization liquid generation device, if the depolymerization reaction is insufficient, a part of an unreacted resin may remain in the device (referred to as a non-depolymerization liquid). At this time, if the temperature of a flow path at an outlet of the device is lower than a melting point (about 225° C.) of the non-depolymerization liquid, that is, PA6, a part of the non-depolymerization liquid is solidified in the flow path. In addition, even if the temperature of the flow path at the outlet is not lower than the melting point, the viscosity of the non-depolymerization liquid is higher near the melting point as compared with a case where the temperature is sufficiently higher than the melting point (for example, 250° C. or higher), so that the non-depolymerization liquid is less likely to be discharged through the flow path. Therefore, at the time of the start operation, by increasing the temperature of the flow path at the outlet of the device to be sufficiently higher than the melting point of the non-depolymerization liquid, solidification and retention of the non-depolymerization liquid can be prevented, so that it is possible to contribute to stable operation of the device.

The configuration of such a depolymerization liquid generation device will be described in more detail with reference to the drawings.

### <Configuration of Device>

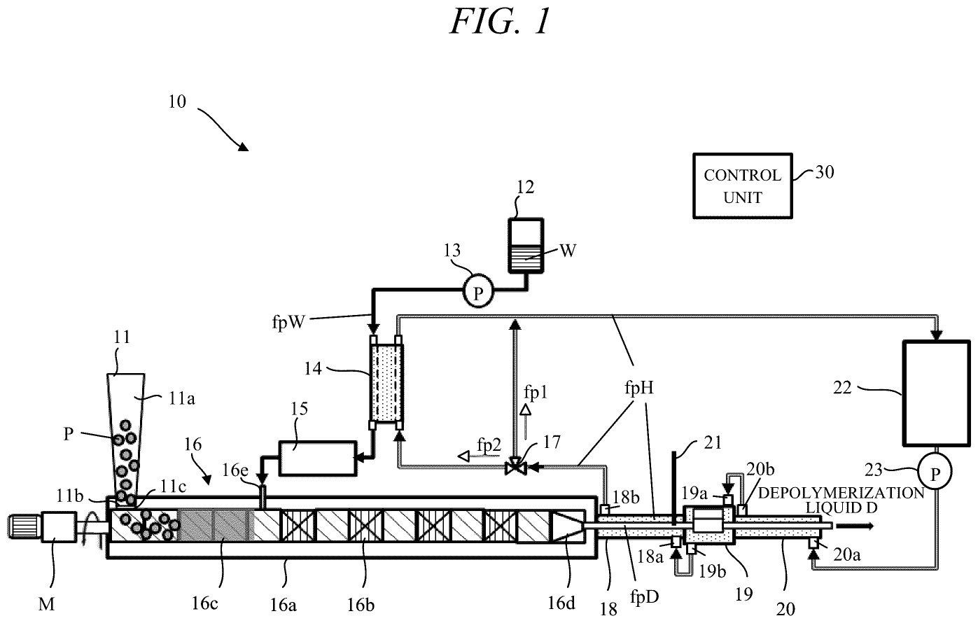

FIG. 1 is a schematic diagram illustrating an example of a configuration of a depolymerization liquid generation device 10 according to the embodiment. As illustrated in FIG. 1, the depolymerization liquid generation device 10 includes a hopper 11 to which polyamide resins P as a raw material are input, a tank 12 in which supply water W is stored, a first pump 13 that sends the supply water W stored in the tank 12, a second heat exchange unit 14 that performs heat exchange between the supply water W and a heat medium, an auxiliary heating unit 15 that heats the supply water W, a kneader 16 that kneads the polyamide resin P and the supply water W, a switching valve 17 that switches a flow path fpH of the heat medium used for the heat exchange, a first heat exchange unit 18 that performs heat exchange between the depolymerization liquid D flowing out of the kneader 16 and the heat medium, a back pressure valve 19 that is provided on the downstream side (right side in FIG. 1) of the depolymerization liquid D in the first heat exchange unit 18, a third heat exchange unit 20 that performs heat exchange between the depolymerization liquid D having passed through the back pressure valve 19 and the heat medium, a temperature sensor 21 that measures the temperature of the depolymerization liquid D flowing to the back pressure valve 19, a temperature controller 22 that adjusts the temperature of the heat medium, a second pump 23 that sends the heat medium, and a control unit 30.

The hopper 11 is connected to the upstream side (left side in FIG. 1) of the kneader 16, and supplies the put polyamide resin P to the kneader 16. More specifically, the hopper 11 includes an accommodation portion 11a configured to be able to accommodate the polyamide resin P, and an opening/closing portion 11b capable of switching between a supply state in which the polyamide resin P accommodated in the accommodation portion 11a is supplied to the kneader 16 and a blocking state in which the supply to the kneader 16 is blocked. The accommodation portion 11a is formed in a substantially trapezoidal shape in longitudinal cross-sectional view, and is configured to be able to supply the polyamide resin P to the kneader 16 from a supply port 11c provided at a lower end. The opening/closing portion 11b is provided in the supply port 11c, and the amount of the polyamide resin P supplied to the kneader 16 is adjusted by controlling the opening/closing portion 11b.

The tank 12 stores the supply water W. The pressure of the supply water W stored in the tank 12 is increased (for example, 17.5 MPa) by driving of the first pump 13, and the supply water W is supplied to the kneader 16 through the second heat exchange unit 14 and the auxiliary heating unit 15. The supply water W is supplied to the kneader 16 through a droplet nozzle 16e. The position of the droplet nozzle 16e in the kneader 16 is on the downstream side (right side in FIG. 1) of the connection portion (position where the polyamide resin P is supplied) of the hopper 11.

The first pump 13 increases the supply pressure of the supply water W to 17.5 MPa described above. As an example, the temperature of the supply water W sent from the first pump 13 is set to 30° C., and the flow rate is set to 30 kg/h. The second heat exchange unit 14 may be a plate type, a double pipe type, or a multi-pipe type. The second heat exchange unit 14 increases the temperature of the supply water W flowing through a supply path fpW from 30° C. to about 320° C. by exchanging heat between the high-temperature (for example, about 340° C.) heat medium and the supply water W at the time of the steady operation. The heat medium input from a flow path fp2 of the heat medium to the second heat exchange unit 14 is heated to, for example, about 340° C. by the first heat exchange unit 18 described later. In the present embodiment, a state in which the temperature of the kneader 16 reaches a predetermined temperature (for example, 340° C.) and the depolymerization reaction proceeds is referred to as a steady state, and the operation in this state is referred to as steady operation. In addition, the operation from the start of the operation of the depolymerization liquid generation device 10 to the steady state is referred to as start operation.

Note that the second heat exchange unit 14 does not perform heat exchange at the time of the start operation. More specifically, since the flow path fp2 of the heat medium is stopped by the switching valve 17 to be described later, the supply water W flows to the auxiliary heating unit 15 through the second heat exchange unit 14 while maintaining the temperature of 30° C.

The auxiliary heating unit 15 includes a heater or the like capable of heating an internal pipe through which the supply water W flows. The auxiliary heating unit 15 increases the temperature of the supply water W to about 350° C. at the time of both the steady operation and the start operation.

By increasing the temperature of the supply water W to about 350° C., when the supply water W is injected into the kneader 16 through the droplet nozzle 16e, the temperature of the melted polyamide resin P is prevented from being lowered to cause solidification at the tip of the droplet nozzle 16e due to the low temperature of the supply water W.

The kneader 16 includes an extruder in which a screw 16b is stored in a cylindrical cylinder 16a, and is configured such that the inside of the cylinder 16a is under the subcritical conditions. More specifically, in the cylinder 16a, a heating unit 16c is provided between the connection portion of the hopper 11 and the droplet nozzle 16e. The inside of the cylinder 16a is heated by the heating unit 16c, and the temperature in the cylinder 16a is maintained at, for example, 350° C. The polyamide resin P put from the hopper 11 is melted in the heated cylinder 16a.

A downstream end 16d of the cylinder 16a is formed in a tapered shape (diaphragm shape). When the screw 16b is rotated by a motor M to extrude the polyamide resin P and the supply water W to the downstream side while kneading the polyamide resin P and the supply water W, the pressure in the cylinder 16a becomes a high pressure of, for example, 17 MPa or more because the flow path is narrowed in the back pressure valve 19 described later. In this way, the inside of the cylinder 16a is under the subcritical conditions, and the polyamide resin P and the supply water W are kneaded under the subcritical conditions, so that the polyamide resin P is depolymerized.

In the cylinder 16a, the subcritical conditions are held by the back pressure valve 19 provided on the downstream side of the depolymerization liquid D in the first heat exchange unit 18 connected to the downstream end 16d. Note that the temperature of the downstream end 16d of the cylinder 16a is slightly lower than the temperature (350° C.) on the upstream side of the cylinder 16a.

The kneader 16 includes, for example, a twin-screw extruder in which two screws 16b are stored.

The first heat exchange unit 18, the back pressure valve 19, and the third heat exchange unit 20 are connected to the downstream side (right side in FIG. 1) of the kneader 16. A flow path fpD of the depolymerization liquid D communicates from the downstream end 16d of the kneader 16 through the first heat exchange unit 18, the back pressure valve 19, and the third heat exchange unit 20 to a device (not illustrated) in charge of a process after the decomposition process, such as a device for recovering monomers in the depolymerization liquid.

On the other hand, the heat medium sent from the second pump 23 is sent to the switching valve 17 through the outer peripheral portion of the third heat exchange unit 20, the periphery of the back pressure valve 19, and the outer peripheral portion of the first heat exchange unit 18.

As an example, the first heat exchange unit 18 and the third heat exchange unit 20 are configured by coaxial heat exchangers. For example, the back pressure valve 19 is connected between an inner pipe of the first heat exchange unit 18 and an inner pipe of the third heat exchange unit 20, and the inner pipe of the first heat exchange unit 18→the back pressure valve 19→the inner pipe of the third heat exchange unit 20 is defined as the flow path fpD of the depolymerization liquid D described above. In FIG. 1, the flow path fpD of the depolymerization liquid D is illustrated in white.

In addition, the periphery of the back pressure valve 19 is covered with a jacket (not illustrated), and the outer peripheral portion of the inner pipe in the first heat exchange unit 18, the inside of the jacket around the back pressure valve 19, and the outer peripheral portion of the inner pipe in the third heat exchange unit 20 are connected to obtain the flow path fpH of the heat medium. In FIG. 1, the flow path fpH of the heat medium in the first heat exchange unit 18, the back pressure valve 19, and the third heat exchange unit 20 are illustrated by fine dots.

The heat medium sent from the second pump 23 is input from an input unit 20a on the outer peripheral portion of the third heat exchange unit 20 to the outer peripheral portion of the third heat exchange unit 20. Subsequently, the heat medium is input into the jacket through an output unit 20b on the outer peripheral portion of the third heat exchange unit 20 and an input unit 19a of the jacket covering the periphery of the back pressure valve 19. Further, the heat medium is input to the outer peripheral portion of the first heat exchange unit 18 through an output unit 19b of the jacket covering the periphery of the back pressure valve 19 and an input unit 18a on the outer peripheral portion of the first heat exchange unit 18. Furthermore, the heat medium is output from an output unit 18b on the outer peripheral portion of the first heat exchange unit 18 to the switching valve 17.

Note that the first heat exchange unit 18 and the third heat exchange unit 20 may be configured by, for example, a double-pipe heat exchanger or a multi-pipe heat exchanger instead of the coaxial heat exchanger.

Instead of causing the heat medium to flow in the jacket covering the periphery of the back pressure valve 19, a heat block may be provided so as to surround the back pressure valve 19, and the heat medium may flow in the heat block.

Furthermore, although the example in which the first heat exchange unit 18, the back pressure valve 19, and the third heat exchange unit 20 are configured separately and connected has been described, the first heat exchange unit 18, the back pressure valve 19, and the third heat exchange unit 20 may be integrally configured.

With the configuration described above, heat exchange is performed between the high-temperature (about 340° C.) depolymerization liquid D flowing out of the kneader 16 and the heat medium adjusted to a predetermined temperature by the temperature controller 22 described later. The heat exchange at the time of the steady operation will be described in detail below.

The depolymerization liquid D extruded from the downstream end 16d of the cylinder 16a of the kneader 16 flows through the inner pipe of the first heat exchange unit 18 toward the back pressure valve 19, the pressure of the depolymerization liquid D is adjusted by the back pressure valve 19 (17 MPa), and the depolymerization liquid D further flows through the inner pipe of the third heat exchange unit 20 to the right side toward the outlet.

On the other hand, the heat medium (about 40° C. at the time of the steady operation) sent from the second pump 23 flows through the outer peripheral portion of the third heat exchange unit 20 toward the back pressure valve 19, and flows through the outer peripheral portion of the first heat exchange unit 18 toward the output unit 18b through the jacket covering the back pressure valve 19.

By causing the depolymerization liquid D at about 340° C. and the heat medium at about 40° C. to flow through each of the inner pipe and the outer peripheral portion, the heat of the depolymerization liquid D is conducted to the heat medium, and the depolymerization liquid D is cooled to a predetermined temperature (for example, about 100° C.) in the third heat exchange unit 20. By lowering the temperature of the depolymerization liquid D, it is possible to prolong the life of a consumable member, an O-ring, a diaphragm, and the like inside the back pressure valve 19. However, when the depolymerization liquid D is cooled to 90° C., all the depolymerization liquid D becomes a liquid, and in the embodiment, the depolymerization liquid D is excessively cooled. That is, the thermal energy in the case of concentrating the depolymerization liquid D in the process after the decomposition process is increased.

On the other hand, the heat medium is heated by the depolymerization liquid D and heated to a predetermined temperature (for example, 340° C.) at the output unit 18b of the first heat exchange unit 18.

The heat exchange at the time of the start operation will be described in detail below.

The non-depolymerization liquid extruded from the downstream end 16d of the cylinder 16a of the kneader 16 flows through the inner pipe of the first heat exchange unit 18 toward the back pressure valve 19, passes through the back pressure valve 19, and flows through the inner pipe of the third heat exchange unit 20 to the right side toward the outlet.

On the other hand, the heat medium (about 250° C. at the time of the start operation) sent from the second pump 23 flows through the outer peripheral portion of the third heat exchange unit 20 toward the back pressure valve 19, and flows through the outer peripheral portion of the first heat exchange unit 18 toward the output unit 18b through the jacket covering the back pressure valve 19.

By causing the non-depolymerization liquid (for example, about 220° C.) and the heat medium (about 250° C.) to flow through each of the inner pipe and the outer peripheral portion, the heat of the heat medium is conducted to the non-depolymerization liquid, and the non-depolymerization liquid is maintained at a predetermined temperature (for example, about 250° C.) in the third heat exchange unit 20. 250° C. is higher than a melting point (about 225° C.) of the non-depolymerization liquid, that is, PA6 in the embodiment.

The temperature sensor 21 measures the temperature of the depolymerization liquid D flowing to the back pressure valve 19. A temperature detection signal by the temperature sensor 21 is sent to, for example, the control unit 30. As a result, the control unit 30 can perform predetermined control by monitoring the temperature of the depolymerization liquid D. For example, in the heat exchange by the first heat exchange unit 18, the back pressure valve 19, and the third heat exchange unit 20 described above, the temperature of the depolymerization liquid D in the third heat exchange unit 20 is designed to be about 100 to 120° C. when the flow rate of the heat medium is 60 kg/h based on a heat transfer area between the inner pipe and the outer peripheral portion, a total heat transfer coefficient, and the like in the design stage. By changing the flow rate of the heat medium, the control unit 30 can adjust the amount of heat exchange so that the temperature detected by the temperature sensor 21 becomes 100 to 120° C. described above. Note that the flow rate of the heat medium can be changed by adjusting the output of the second pump 23, for example.

The temperature controller 22 heats or cools the input heat medium to adjust the temperature of the heat medium to a set temperature and outputs the heat medium.

The set temperature of the temperature controller 22 at the time of the steady operation is, for example, about 40° C., and the set temperature at the time of the start operation is, for example, about 250° C.

The second pump 23 sends the heat medium at a pressure of, for example, 0.1 MPa. As an example, the temperature of the heat medium sent from the second pump 23 conforms to the set temperature of the temperature controller 22, and the flow rate is 60 kg/h.

The switching valve 17 is configured by, for example, a three-way valve or the like. The switching valve 17 switches the destination of the heat medium input to the switching valve 17 through the flow path fpH of the heat medium to the flow path fp1 or the flow path fp2 based on a signal from the control unit 30. The switching valve 17 switches to the flow path fp1 at the time of the start operation and switches to the flow path fp2 at the time of the steady operation. The control unit 30 is configured to include a computer including an arithmetic unit (processor) such as a CPU (microprocessor), a storage unit (memory) such as a ROM or a RAM, and other peripheral circuits (not illustrated) such as an I/O interface.

### <Description of Flow Chart>

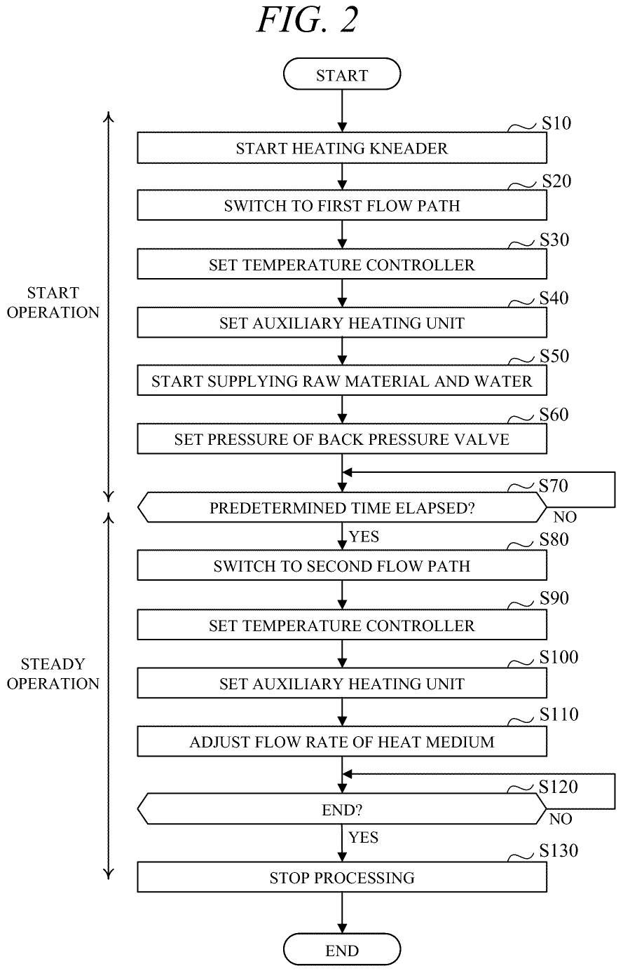

FIG. 2 is a flow chart illustrating an example of process flow during operation of the depolymerization liquid generation device 10. S10 (S: processing step) to S70 correspond to start operation, and S80 and beyond correspond to steady operation. The control unit 30, for example, when an operator initiates the start operation, begins the process shown in FIG. 2 according to a predetermined program.

At S10 in FIG. 2, the control unit 30 starts heating the kneader 16 and proceeds to S20.

At S20, the control unit 30 switches the flow path fpH of the heat medium to the first flow path by the switching valve 17 and proceeds to S30. The first flow path corresponds to the flow path fp1.

At S30, the control unit 30 sets the temperature controller 22. The control unit 30 sets the temperature of temperature controller 22 to, for example, approximately 250° C. and proceeds to S40.

At S40, the control unit 30 sets the auxiliary heating unit 15. The control unit 30 sets the temperature of the auxiliary heating unit 15 to, for example, approximately 350° C. and proceeds to S50.

At S50, the control unit 30 starts supplying the polyamide resin P as the raw material and the supply water W and proceeds to S60.

At S60, the control unit 30 sets the pressure of the back pressure valve 19 and proceeds to S70. The setting pressure of the back pressure valve 19 is set to slowly increase from 0 MPa to 17 MPa, for example.

At S70, the control unit 30 determines whether a predetermined time has elapsed since the start of supplying the raw material and the supply water W. The predetermined time in this embodiment corresponds to the time for the depolymerization reaction in the kneader 16 and the time required to heat the first heat exchange unit 18, the back pressure valve 19, and the third heat exchange unit 20 to approximately 250° C. with the heat medium.

If, for example, 15 minutes as the predetermined time have passed, the control unit 30 affirms S70 and proceeds to S80; if less than 15 minutes have passed, the control unit 30 denies S70 and repeats the determination process.

At S80, the control unit 30 switches the flow path fpH of the heat medium to the second flow path by the switching valve 17 and proceeds to S90. The second flow path corresponds to the flow path fp2. At S90, the control unit 30 sets the temperature controller 22. The control unit 30 sets the temperature of temperature controller 22 to, for example, approximately 40° C. and proceeds to S100. At S100, the control unit 30 sets the auxiliary heating unit 15. The control unit 30 continues to set the temperature of the auxiliary heating unit 15 to, for example, approximately 350° C. and proceeds to S110.

At S110, the control unit 30 adjusts the flow rate of the heat medium and proceeds to S120. The flow rate adjustment is to change the flow rate of the heat medium so that the temperature detected by the temperature sensor 21 is 120-140° C., thereby adjusting the amount of heat exchange by the first heat exchange unit 18, the back pressure valve 19, and the third heat exchange unit 20, as described above.

At S120, the control unit 30 determines whether an end operation has been performed by the operator. If an end operation has been performed, the control unit 30 affirms S120 and proceeds to S130. If no end operation has been performed, the control unit 30 denies S120 and continues the steady operation.

At S130, the control unit 30 performs the predetermined stop processing to stop the process in FIG. 2.

According to the present embodiment, the following effects can be achieved.

(1) The depolymerization liquid generation device 10 includes: the kneader 16 as a depolymerization liquid generation unit that kneads the polyamide resin P as plastic and the supply water W under a heating environment to generate the depolymerization liquid D; the back pressure valve 19 that adjusts the pressure of the depolymerization liquid D output from the kneader 16; the first heat exchange unit 18 that is provided in the flow path fpD between the kneader 16 and the back pressure valve 19; the second heat exchange unit 14 that is provided in the supply path fpW of the supply water W supplied to the kneader 16; the temperature controller 22 that adjusts the temperature of the heat medium circulating through the first heat exchange unit 18 and the second heat exchange unit 14; and the switching valve 17 that switches between the first flow path fp1 for circulating the heat medium from the temperature controller 22 to the temperature controller 22 through the first heat exchange unit 18, and the second flow path fp2 for circulating the heat medium from the temperature controller 22 to the temperature controller 22 through the first heat exchange unit 18 and the second heat exchange unit 14.

With this configuration, the generated depolymerization liquid D can be appropriately cooled, and the device 10 can be stably operated.

For example, by switching between the first flow path fp1 and the second flow path fp2 according to the operation state of the device 10, it is possible to appropriately heat the flow path fpD and the like and cool the depolymerization liquid D and the like.

(2) In the depolymerization liquid generation device 10 of the above (1), the switching valve 17 switches to the first flow path fp1 at the time of the start operation from the start of the operation of the device 10 to the steady state, and switches to the second flow path fp2 at the time of the steady operation after reaching the steady state.

With this configuration, at the time of the start operation of the device 10, the flow path fpD through which the non-depolymerization liquid flows can be effectively heated by, for example, heat exchange in the first heat exchange unit 18 or the like using the heat of the heat medium heated by the temperature controller 22.

On the other hand, at the time of the steady operation of the device 10, for example, the heating in the temperature controller 22 is stopped to reduce the energy consumed in the temperature controller 22, and the heat exchange in the first heat exchange unit 18 or the like that cools the depolymerization liquid D at about 340° C. output from the kneader 16 and the heat exchange in the second heat exchange unit 14 that heats the supply water W using the heat obtained by the heat exchange can be appropriately performed.

(3) In the depolymerization liquid generation device 10 of the above (2), the temperature controller 22 adjusts the temperature of the heat medium to a first temperature (for example, 250° C.) higher than the melting point (about 225° C.) of the non-depolymerization liquid in a case where the depolymerization reaction is insufficient at the time of the start operation.

With this configuration, even if the non-depolymerization liquid flows from the downstream end 16d of the kneader 16 to the flow path fpD connected to the first heat exchange unit 18, the back pressure valve 19, and the third heat exchange unit 20, it is possible to prevent solidification and retention in the flow path fpD and contribute to stable operation of the device 10.

(4) In the depolymerization liquid generation device 10 of the above (3), the temperature controller 22 adjusts the temperature of the heat medium to a second temperature (for example, about 40° C.) lower than the first temperature (about 250° C.) at the time of the steady operation.

With this configuration, it is possible to reduce energy used in the temperature controller 22 as compared with a case where the temperature controller 22 continues temperature adjustment to the first temperature even after the device 10 shifts from the start operation to the steady operation.

(5) In the depolymerization liquid generation device 10 of the above (1), the switching valve 17 switches to the first flow path fp1 before the elapsed time from the start of operation of the device 10 reaches a predetermined retention time (about 15 minutes), and switches to the second flow path fp2 after the elapsed time reaches the predetermined retention time. The predetermined retention time in the embodiment refers to a time sufficient for the depolymerization reaction.

With this configuration, at the time of the start operation before the elapsed time from the start of operation reaches 15 minutes, the flow path fpD through which the non-depolymerization liquid flows can be effectively heated by, for example, heat exchange in the first heat exchange unit 18 or the like using the heat of the heat medium heated by the temperature controller 22.

On the other hand, at the time of the steady operation after a lapse of 15 minutes from the start of operation, for example, the heating in the temperature controller 22 is stopped to reduce the energy consumed in the temperature controller 22, and heat exchange in the first heat exchange unit 18 or the like that cools the depolymerization liquid D at about 340° C. output from the kneader 16 and heat exchange in the second heat exchange unit 14 that heats the supply water W using the heat obtained by the heat exchange can be appropriately performed.

(6) In the depolymerization liquid generation device 10 of the above (1) to (5), when the switching valve 17 is switched to the first flow path fp1, the first heat exchange unit 18 keeps the flow path fpD and the back pressure valve 19 warm, and when the switching valve 17 is switched to the second flow path fp2, the first heat exchange unit 18 cools the depolymerization liquid D output from the kneader 16, and the second heat exchange unit 14 heats the supply water W supplied to the kneader 16.

With this configuration, when the heat medium circulates through the first flow path fp1, for example, the flow path fpD and the like through which the non-depolymerization liquid flows can be effectively kept warm by heat exchange in the first heat exchange unit 18 and the like using the heat of the heat medium heated by the temperature controller 22.

On the other hand, when the heat medium circulates through the second flow path fp2, for example, the heating in the temperature controller 22 is stopped to reduce the energy consumed in the temperature controller 22, and the heat exchange in the first heat exchange unit 18 or the like that cools the depolymerization liquid D at about 340° C. output from the kneader 16 and the heat exchange in the second heat exchange unit 14 that heats the supply water W using the heat obtained by the heat exchange can be appropriately performed.

The above embodiment may be modified into various forms. Hereinafter, modifications will be described.

### (First Modification)

In the above description, the third heat exchange unit 20 is provided on the downstream side of the back pressure valve 19, but the third heat exchange unit 20 may be omitted. This is because the first heat exchange unit 18 is provided to cool the temperature of the depolymerization liquid D from about 340° C. to about 100° C. by about 240° C. to heat the heat medium from about 40° C. to about 340° C. by about 300° C., whereas the third heat exchange unit 20 is provided to keep the temperature of the depolymerization liquid D at about 100° C. Therefore, when the temperature of the depolymerization liquid D does not need to be kept at about 100° C., the third heat exchange unit 20 may be omitted.

### (Second Modification)

In the above description, an example has been described in which the stop processing (S130) is performed as it is when the depolymerization liquid generation device 10 is stopped after the steady operation (positive determination in S120). Alternatively, the stop processing may be performed after the inside of the device 10 is cleaned using a cleaning resin agent (purge material).

For example, when the recommended temperature of the purge material is 200°0 C., the set temperature of the temperature controller 22 is changed from 40° C. at the time of the steady operation to 200° C. to heat the flow path fpD in the first heat exchange unit 18, the back pressure valve 19, and the third heat exchange unit 20 so that the purge material does not solidify in the flow path fpD. In order to stop the supply of the supply water W to the kneader 16 at the time of cleaning, the flow path of the heat medium is switched to the first flow path fp1 by the switching valve 17. The stop processing such as stopping the supply of the heat medium is performed after the cleaning processing is completed.

The above embodiment can be combined as desired with one or more of the aforesaid modifications. The modifications can also be combined with one another. According to the present invention, it becomes possible to appropriately cool the generated depolymerization liquid thereby contributing to stable operation.

Above, while the present invention has been described with reference to the preferred embodiments thereof, it will be understood, by those skilled in the art, that various changes and modifications may be made thereto without departing from the scope of the appended claims.

1. A depolymerization liquid generation device, comprising:
a depolymerization liquid generation unit configured to knead plastic and water under a heating environment to generate depolymerization liquid;
a back pressure valve configured to adjust pressure of the depolymerization liquid from the depolymerization liquid generation unit;
a first heat exchange unit provided in a flow path between the depolymerization liquid generation unit and the back pressure valve;
a second heat exchange unit provided in a supply path of the water supplied to the depolymerization liquid generation unit;
a temperature controller configured to adjust temperature of heat medium circulating through the first heat exchange unit and the second heat exchange unit; and
a switching valve configured to switch between a first flow path for circulating the heat medium from the temperature controller to the temperature controller through the first heat exchange unit and a second flow path for circulating the heat medium from the temperature controller to the temperature controller through the first heat exchange unit and the second heat exchange unit.

2. The depolymerization liquid generation device according to claim 1, wherein
the switching valve switches to the first flow path in a start operation from start of operation of the depolymerization liquid generation device to a steady state, and switches to the second flow path in a steady operation after reaching the steady state.

3. The depolymerization liquid generation device according to claim 2, wherein
the temperature controller adjusts the temperature of the heat medium to a first temperature higher than a melting point of non-depolymerization liquid in a case where depolymerization reaction is insufficient in the start operation.

4. The depolymerization liquid generation device according to claim 3, wherein
the temperature controller adjusts the temperature of the heat medium to a second temperature lower than the first temperature in the steady operation.

5. The depolymerization liquid generation device according to claim 4, further comprising:
a third heat exchange unit configured to perform heat exchange between the depolymerization liquid having passed through the back pressure valve and the heat medium, wherein
the first heat exchange unit cools the depolymerization liquid to a predetermined temperature, wherein
the third heat exchange unit keeps the depolymerization liquid at the predetermined temperature.

6. The depolymerization liquid generation device according to claim 1, wherein
the switching valve switches to the first flow path before an elapsed time from the start of operation of the depolymerization liquid generation device reaches a predetermined retention time and switches to the second flow path after the elapsed time reaches the predetermined retention time.

7. The depolymerization liquid generation device according to claim 1, wherein
the first heat exchange unit keeps temperature of the flow path and the back pressure valve when the switching valve switches to the first flow path, wherein
the first heat exchange unit cools the depolymerization liquid from the depolymerization liquid generation unit and the second heat exchange unit heats the water supplied to the depolymerization liquid generation unit when the switching valve switches to the second flow path.

8. The depolymerization liquid generation device according to claim 2, wherein
the steady state is a state in which temperature of the depolymerization liquid generation unit reaches a predetermined high temperature and depolymerization reaction proceeds.
